(19) United States
(12) Patent Application Publication
(10) Pub. No.: US 2010/0175918 A1
(43) Pub. Date: Jul. 15, 2010

(54) CABLE BRIDGE

(76) Inventor: Jicai Ma, Jiangsu (CN)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 12/160,975

(22) PCT Filed: Jul. 20, 2006
(86) PCT No.: PCT/CN2006/001494

§ 371 Date: Mar. 29, 2010

(30) Foreign Application Priority Data
Feb. 27, 2006 (CN) 200620069615.0

(51) Int. Cl. F16L 3/02; F16L 3/00; H02G 3/04

(52) U.S. Cl. 174/481; 248/49

(57) ABSTRACT

A cable bridge comprises side plates (1) and bottom plates (2). A protruding groove (11) extending in the length direction of the side plate is arranged on the lower part of the side plate, and both sides of the bottom plate are fixed on the bottom edges of the lower part of the side plates, respectively. In addition, the protruding groove (11) on the side plate protrudes outwardly, with a semi-circular, arc, triangular, or rectangular cross-section.

### FIELD OF THE INVENTION

The present invention relates to a cable bridge applicable to cabling of power cables or communication cables, and pertains to power line facility manufacturing field.

### BACKGROUND OF THE INVENTION

At present, cable bridges produced in China are in two types: one type is in plate structure, which is produced as follows: the steel plates are formed by machining such as cutting, folding, pressing and electric welding; the two side plates are formed by cold bending, and then welded to a flat bottom plate to form the cable bridge in plate structure. In order to meet the requirements for bearing capacity and ensure that the deflection of the cable bridge doesn't exceed 1/200, the steel sheets can be in thickness of 1.5, 2.0, 2.5, or 3.0 mm, depending on the specification of the cable bridge decided by the amount of the cable laying. Such cable bridges have the following drawbacks: a. low strength; b. heavy self-weight; c. high cost; d. poor ventilation and heat exhaust performance because no thermal emission hole is arranged on the groove type bridge, and the thermal emission hole s on the flat bottom plate are blocked by the cables on tray-type bridges,). On the other type of the cable bridge, both the side plates and the bottom plate are formed by cold bending into concave-convex corrugated structure, and then welded into a tray-type or groove type bridge. Due to the improved structure, such cable bridge has much higher strength, and has the following advantages: a. low self-weight; b. high strength; c. low cost. However, since the bottom plate is in corrugated structure, when the surface is treated by hot galvanizing, residual zinc liquid will remain in the grooves on both sides and drip along the side plates, and thereby cause increased cost and degraded quality of surface treatment; in addition, water accumulation may occur in the grooves on both sides during the pre-treatment for galvanizing and plastic spray coating, and bring difficulties to industrial flow-line production for surface treatment; especially, water accumulation may occur in the grooves on the bottom plate of the groove type cable bridge mounted outdoor. Since no thermal emission hole is arranged on the bottom plate of any groove type cable bridge, there is not vertical air ventilation effect.

### SUMMARY OF THE INVENTION

Object: the object of the present invention is to provide a cable bridge, which has low self-weight, low cost, high strength, and has efficacy of deliverling vertical air ventilation and heat exhaust not matter whether thermal emission holes are arranged on the bottom plate or not, and thereby can reduce resistivity and resistance of the cable lines, and thereby improve power utilization ratio and save electric energy; in addition, the cable bridge can overcome the drawback of water or zinc accumulation in the grooves on the bottom plate during surface treatment for the corrugated structure, and deliver automatic water drainage function when the cable bridge is mounted outdoor.

Technical scheme: the cable bridge provided in the present invention comprises side plates and bottom plates, wherein, a protruding groove extending in the length direction of the side plate is arranged on the lower part of the side plate, and both sides of the bottom plate are fixed on the bottom edges of the lower part of the side plates, respectively.

The protruding groove on the side plate protrudes outwardly, with a semi-circular, arc, triangular, or rectangular cross-section; one or more rib grooves can be arranged on the side plate in the length direction of the side plate; in addition, connecting holes can be arranged on the side plate; the bottom plate is a corrugated bottom plate formed by connecting protruding grooves and concave grooves in alternate successively, and thermal emission holes can be arranged on the corrugated bottom plate.

Since there is a protruding groove extending in length direction of the side plate on the lower part of each side plate and the protruding groove is fixed between the side plate and an end face of the corrugated bottom plate, an air ventilating and water flowing space is formed in length direction of the side plate at the junction line between the end face of the corrugated bottom plate and the side plate, so that air can flow from an edge of the bottom plate into the protruding groove and then into the cable bridge, while water in the cable bridge can flow from the cable bridge into the protruding groove and then flow from the protruding groove out of the bottom plate. Especially, all liquid and water accumulated during the pre-treatment for surface treatment (hot dip galvanizing, electro-galvanizing, and plastics spray coating) can flow from the protruding grooves on the side plates. In that way, the most difficult problem in the surface treatment process for cable bridges in corrugated structure is solved completely.

Technical effects: on the air permeable and power-saving light-weight cable bridge provided in the present invention, since a protruding groove extending in length direction is arranged on the lower part of the side plate, any water accumulated in the cable bridge and liquid accumulated during surface treatment can be drained out effectively; in addition, no matter whether thermal emission holes are arranged on the bottom plate or not, the cable bridge provides favorable condition for air flow and heat exchange vertically, which further improves heat exhaust effect. With the air permeation effect of the protruding grooves on lower part of the side plates and the heat exhaust effect of the corrugated bottom plate, the heat generated from the conductors of cables laid in the cable bridge can be exhausted effectively, so that the resistivity and resistance of the cable lines can be reduced; in that way, the cable bridge can improve power utilization ratio and save electric power. In addition, the protruding groove design of the product enhances overall rigidity and strength of the cable bridge, so that the cable bridge can be made with thinner steel sheets; therefore, the overall weight of the cable bridge can be further reduced, and material consumption and cost can be reduced greatly. With the cable bridge provided in the present invention, 30% or more steel sheet resource can be saved.

### BRIEF DESCRIPTION OF THE DRAWINGS

FIG. 1 is a schematic diagram of overall structure of the present invention.

FIG. 2 is a right view of the structure shown in FIG. 1.

FIG. 3 is a top view of the structure shown in FIG. 2.

FIG. 4 is an enlarged diagram of the structure at point A in FIG. 2.

FIG. 5 is an enlarged sectional view of the structure at point B in FIG. 3.

FIG. 6 is a schematic diagram of a structure with rib grooves 13 along length direction on side plate 1.

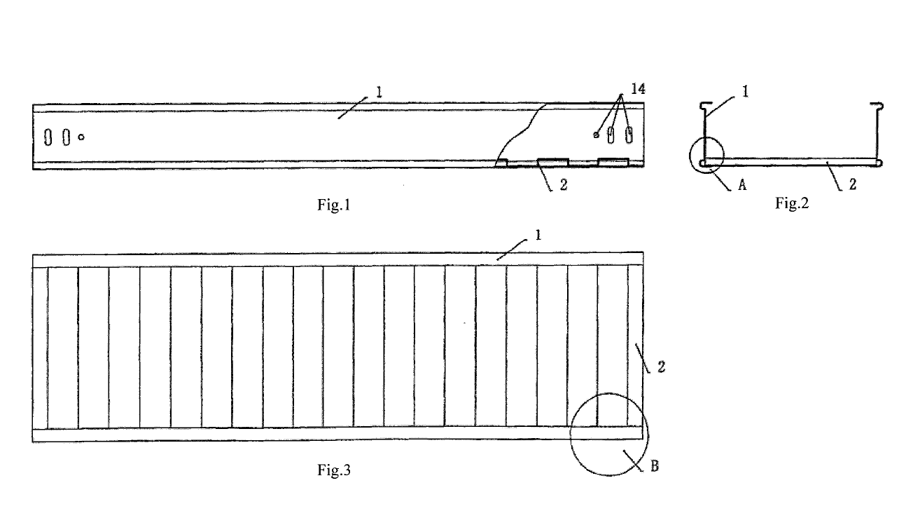

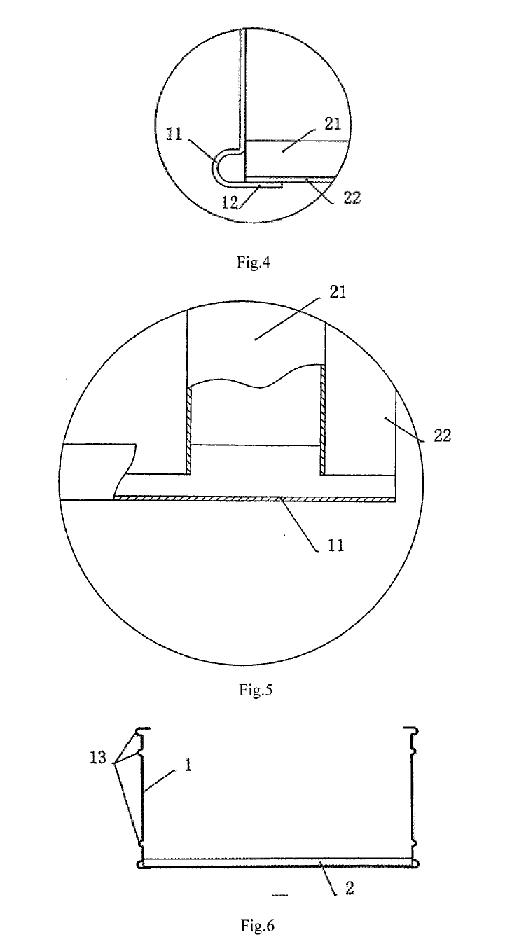

The symbols on above drawings are: side plate 1, protruding groove 11, bottom edge 12, rib groove 13, connecting hole 14, and bottom plate 2.

### DETAILED DESCRIPTION OF THE EMBODIMENTS

The air permeable and power-saving light-weight cable bridge provided in the present invention comprises side plates 1 and bottom plates 2, wherein, a protruding groove extending in the length direction of the side plate is arranged on the lower part of the side plate, both sides of the bottom plate 2 are fixed on the bottom edges 12 of the lower part of the side plates, and the bottom plate 2 doesn't extend into the protruding grooves 11. Both the side plates 1 and the bottom plate 2 are made with steel sheets in thickness of 0.8 mm by cold bending (after cold bending, the strength of the steel sheets is equivalent to the strength of steel sheets in thickness of 3.0 mm, which are used in ordinary cable bridges). In order to enhance the strength of the side plate 1, one, two, or three rib grooves 13 are arranged on the side plate 1 along the length direction of the side plate 1. For the convenience of the connection of the air permeable and power-saving light-weight cable bridge, the connecting holes 14 are arranged on the side plate 1. The bottom plate 2 is a corrugated bottom plate made by connecting protruding grooves and concave grooves in alternate successively. In order to further improve the heat exhaust effect, thermal emission holes can be arranged on the corrugated bottom plate.

1. An air-permeable and power-saving light-weight cable bridge, which comprises side plates and bottom plates, wherein, a protruding groove extending in the length direction of the side plate is arranged on the lower part of the side plate, and both sides of the bottom plate are fixed on the bottom edges of the lower part of the side plates, respectively.

2. The air-permeable and power-saving light-weight cable bridge according to claim 1, wherein, the protruding groove on the side plate protrudes outwardly, with a semi-circular, arc, triangular, or rectangular cross-section.

3. The air-permeable and power-saving light-weight cable bridge according to claim 1 or 2, wherein, one or more rib grooves are arranged on the side plate in the length direction of the side plate.

4. The air-permeable and power-saving light-weight cable bridge according to claim 1 or 2, wherein, connecting holes are arranged on the side plate.

5. The air-permeable and power-saving light-weight cable bridge according to claim 1, wherein, the bottom plate is a corrugated bottom plate made by connecting protruding grooves and concave grooves in alternate successively.

6. The air-permeable and power-saving light-weight cable bridge according to claim 1, wherein, thermal emission holes are arranged on the corrugated bottom plate.
